(19) United States
(12) Patent Application Publication
(10) Pub. No.: US 2002/0115748 A1
(43) Pub. Date: Aug. 22, 2002

(54) Glass fiber reinforced styrenic thermoplastic composites containing an aminosilane coupling agent

(75) Inventors: Shi-Choon Lee, Kyungki-do (KR); Byung-Sun Kim, Kyungki-do (KR)

Correspondence Address: Maria Parrish Tungol, 5820 Fifer Drive, Suite 100, Alexandria, VA, 22303, US

(73) Assignee: CHEIL INDUSTRIES INC., Kyungbuk (KR)

(21) Appl. No.: 10/027,327

(22) Filed: Dec. 20, 2001

(30) Foreign Application Priority Data
Dec. 20, 2000 (KR) 2000-79156

(51) Int. Cl. C08K 3/40

(52) U.S. Cl. 523/217; 524/494

(57) ABSTRACT

A styrenic thermoplastic resin composite is disclosed which contains (A) about 50 to 95 parts by weight of a styrene-containing copolymer produced by polymerization of (a1) about 50 to 95 % by weight of styrene, α-methylstyrene, halogen- or alkyl-substituted styrene, or a mixture thereof and (a2) about 5 to 50 % by weight of acrylonitrile, methacrylonitrile, C₁₋₈ methacrylic acid alkyl ester, C₁₋₈ acrylic acid alkyl ester, maleic acid anhydride, C₁₋₄ alkyl or phenyl N-substituted maleimide or a mixture thereof and (B) about 5 to 50 parts by weight of glass fibers and (C) about 0.01 to 5.0 parts by weight of an aminosilane coupling agent. A new method of preparing the styrenic thermoplastic composite is also disclosed, the method comprising admixing a styrene-containing copolymer as a matrix resin with an aminosilane coupling agent in a mixer, extruding the admixture of the styrene-containing copolymer and the aminosilane coupling agent in an extruder, and feeding glass fibers to the melt of the admixture in the middle of the extruder.

### FIELD OF THE INVENTION

The present invention relates to a thermoplastic resin composition which is reinforced with glass fibers. More particularly, the present invention relates to a thermoplastic composite resin composition in which styrene-containing copolymer matrix resin is reinforced with glass fibers and contains an aminosilane coupling agent for the improvement of the surface adhesion, thereby providing a thermoplastic resin composition with enhanced impact strength.

### BACKGROUND OF THE INVENTION

In general, a thermoplastic resin is not used as a composite material for a molded article that requires high strength and accurate dimension, because the resin has poor dimensional stability, creep resistance, heat resistance and strength. To improve these shortcomings, it is well known that the composite resin is reinforced with an inorganic filler such as glass fibers. In preparation of the glass reinforced thermoplastics, it is important to improve the surface adhesion between matrix resin and reinforcing filler. If the surface adhesion becomes poor, the stress on the glass reinforced resin is concentrated to the surface between the matrix resin and reinforcing filler and a crack initiates from the surface so that rigidity and impact strength cannot be improved.

U.S. Pat. No. 3,671,378 to Baer et al. discloses the process for preparing composites from glass fibers and thermoplastic resins which comprises blending the thermoplastic resin matrix with glass concentrate capsules comprising 10 to 80% by weight of glass strands having a length in the range of from 1/32 to 3/4 inch. U.S. Pat. No. 4,405,727 to Brownscombe discloses a reinforced thermoplastic composition comprising a thermoplastic polymer matrix having intimately distributed therein a chemically modified mineral reinforcing component.

International Publication No. WO86/05445 of PCT/US86/00553, herein incorporated by reference, discloses a reinforced polymer composite of the type including (a) a plastic polymer matrix, (b) a reinforcing agent and (c) an interlayer between the polymer. The reinforcing agent is characterized in that the interlayer (1) is elastomeric, and (2) is directly or indirectly bonded to the reinforcing agent. The composites of the patents above are excellent when a matrix resin with reactive functional group such as polyamide resin, a polyester resin and a polycarbonate resin is employed. If a matrix resin without a reactive group such as a polystyrene resin is used, the mechanical properties cannot be improved. Furthermore, it is inconvenient and time consuming to coat the reinforcing agent with a rubber polymer in a separate process.

European Patent Publication No. 0 485 793 Al discloses a process of improving surface adhesion between styrenic resin matrix and reinforcing filler without coating the surface of the reinforcing filler in a separate process. In the European patent application, the surface adhesion to the composite is improved by adding rubber grafted copolymer with tertiary alkylester groups into a matrix resin of acrylonitrile-butadiene-styrene copolymer, resulting in improved impact strength.

U.S. Pat. No. 5,304,591 to Nowakowsky et al., herein incorporated by reference, discloses a thermoplastic molding composition containing a blended resin of a styrene-acrylonitrile copolymer (hereafter “SAN”) and a styrene-methyl methacrylate-maleic anhydride terpolymer as a matrix resin to improve the surface adhesion between the matrix resin and glass fibers, resulting that the impact strength and mechanical properties are improved.

U.S. Pat. No. 5,426,149 to Skarlupka discloses a blend composition comprising at least one epoxy modified styrene/styrene copolymer, at least one resinous styrene-conjugated diene copolymer and glass to improve the surface adhesion between the matrix resin and glass fibers.

U.S. Pat. No. 5,656,684 to Kohler et al. discloses a composite consisting of thermoplastic polycarbonates, special silanes with phthalimide groups and glass fibers in order to improve the surface adhesion between the matrix resin and glass fibers. Such special silanes containing phthalimide groups are not aminosilane type compounds.

The present invention overcomes the shortcomings in the physical properties of the composite material that result when the composite deteriorates due to the poor reactivity between the styrenic copolymer and the glass fibers coated with a coupling agent conventionally used in the prior art. The present inventors have developed a new composite material in which an aminosilane coupling agent is admixed when the matrix resin of styrenic copolymer is compounded, resulting in improved surface adhesion between the matrix resin and glass fibers. A new method of preparing the composite material has also been discovered.

### SUMMARY OF THE INVENTION

A styrenic thermoplastic resin composition according to the present invention comprises (A) about 50 to 95 parts by weight of a styrene-containing copolymer polymerized with (a1) about 50 to 95% by weight of styrene, α-methylstyrene, halogen- or alkyl-substituted styrene, or a mixture thereof and (a2) about 5 to 50% by weight of acrylonitrile, methacrylonitrile, C₁₋₈ methacrylic acid alkyl ester, C₁₋₈ acrylic acid alkyl ester, maleic acid anhydride, C₁₋₄ alkyl or phenyl N-substituted maleimide or a mixture thereof, (B) about 5 to 50 parts by weight of glass fibers and (C) about 0.01 to 5 parts by weight of an aminosilane coupling agent. The new method of preparing the styrenic thermoplastic composite according to the present invention comprises admixing a styrene-containing copolymer as a matrix resin with a coupling agent in a mixer, extruding the admixture of the styrene-containing copolymer and the coupling agent in an extruder, and feeding glass fibers to the melt of the admixture in the middle of the extruder.

The styrenic thermoplastic composites reinforced with glass fibers according to the present invention show improved impact strength and enhanced flexural modulus. A further feature of the present invention provides a new method for preparing the styrenic thermoplastic composite reinforced with glass fibers having good impact strength and flexural modulus. Other advantages of this invention will be apparent from the ensuing disclosure.

### DETAILED DESCRIPTION OF THE INVENTION

A styrenic thermoplastic resin composition according to the present invention comprises (A) about 50 to 95 parts by weight of a styrene-containing copolymer, (B) about 5 to 50 parts by weight of glass fibers and (C) about 0.01 to 5.0 parts by weight of an aminosilane coupling agent.

(A) Styrene-Containing Copolymer

A styrene-containing copolymer is used as a matrix resin in the present invention. The styrene-containing copolymer is prepared by polymerizing (a1) about 50 to 95% by weight of styrene, α-methylstyrene, halogen- or alkyl-substituted styrene, or a mixture thereof and (a2) about 5 to 50% by weight of acrylonitrile, methacrylonitrile, C₁₋₈ methacrylic acid alkyl ester, C₁₋₈ acrylic acid alkyl ester, maleic acid anhydride, C₁₋₄ alkyl or phenyl N-substituted maleimide or a mixture thereof. Preferably, component (a1) is about 50 to 70% by weight and component (a2) is about 30 to 50% by weight of the styrene-containing copolymer. The styrene-containing copolymer is used in an amount of about 50 to 95 parts by weight in the composite.

The C₁₋₈ methacrylic acid alkyl ester is obtained from methacrylic acid and monohydryl alcohol containing 1 to 8 carbon atoms and C₁₋₈ acrylic acid alkyl ester from acrylic acid and monohydryl alcohol containing 1 to 8 carbon atoms. The examples of the acid alkyl ester include methacrylic acid methyl ester, methacrylic acid ethyl ester, acrylic acid methyl ester, acrylic acid ethyl ester, and methacrylic acid propyl ester. Methacrylic acid methyl ester is preferred.

Preferred examples of the styrene-containing copolymer are a copolymer of styrene and acrylonitrile, a terpolymer of styrene, acrylonitrile and methacrylic acid methylester, a copolymer of α-methylstyrene and acrylonitrile, a terpolymer of α-methylstyrene, acrylonitrile and methacrylic acid methylester, and a tetrapolymer of styrene, α-methylstyrene, acrylonitrile and methacrylic acid methylester. A mixture of the copolymers and terpolymers can be used as a matrix resin in this invention. The styrene-containing copolymer is preferably prepared by emulsion, suspension, solution or bulk process, and has a weight average molecular weight (Mw) of about 15,000 to 200,000.

Another preferable example of the styrene-containing copolymer is a copolymer of styrene and maleic acid anhydride, which is prepared by a continuous bulk process or a solution process. The maleic acid anhydride is preferably used in the amount of about 5 to 25% by weight. The copolymer of styrene and maleic acid anhydride has a weight average molecular weight (Mw) of about 20,000 to 200,000 and an intrinsic viscosity of about 0.3 to 0.9.

The styrene for preparation of component (A) in the present invention can be replaced by styrene derivatives such as p-methylstyrene, vinyltoluene, 2,4-dimethylstyrene or α-methylstyrene.

The matrix resin in the present invention optionally further include a modified aromatic vinyl graft copolymer. The modified aromatic vinyl graft copolymer is prepared by grafting about 20 to 99% by weight of a monomer mixture onto about 1 to 80% by weight of a rubber polymer. Rubber polymers that can be used include a diene rubber, an ethylene rubber and/or an ethylene/propylene diene terpolymer rubber, having an average particle size up to 1.0 μm preferably about 0.05 to 0.5 μm. The monomer mixture comprise (D1) styrene, parα-t-butyl styrene, alphα-methylstyrene, betα-methylstyrene, vinylxylene, monochlorstyrene, dichlorostyrene, dibromostyrene, chlorostyrene, ethylstyrene, vinylnaphthalene, divinylbenzene or a mixture thereof; and (D2) acrylonitrile, methacrylonitrile, acrylic acid ester, maleic acid anhydride or a mixture thereof. The preferred monomer mixture comprises (D1) styrene, alphα-methylstyrenc or a mixture thereof and (D2) acrylonitrile, methacrylonitrile or a mixture thereof.

The modified aromatic vinyl graft copolymer can be used in an amount up to about 35 parts by weight and can be included in the process of admixing the styrene-containing copolymer with the aminosilane coupling agent in a mixer.

(B) Glass Fibers

Glass fibers are employed in the composite of the present invention to reinforce the matrix resin. It is preferable to use glass fibers coated with a sizing composition. In the present invention, the glass fibers are E-glass and are chopped glass fibers having a diameter about from 8 to 20 μm and a length about from 3 to 6 mm. The glass fibers are used in an amount of about 5 to 50 parts by weight, preferably in an amount of about 10 to 40 parts by weight.

Glass fibers are treated with a sizing composition during or after preparation thereof. The sizing composition includes lubricants, coupling agents and surfactants. The lubricants are used to form good strands during preparation of the glass fibers. Conventional coupling agents are used to provide the matrix resin and glass fibers with good adhesion. The lubricants, coupling agents and surfactants useful for treating the glass fibers are known in the art and can be easily selected by an ordinary skilled person in the art, depending on the matrix resin and glass fibers, to reinforce the composite.

A conventional coupling agent is a silane coupling agent represented by the following formula:

YRSiX₃

where Y is an organic functional group that can react with a matrix resin, which is selected from the group consisting of vinyl, epoxy, mercaptan, amine and acryl, R is a C₁₋₅ alkyl group and X is an ethoxy group or a halogen atom. Suitable coupling agents are also disclosed in International Publication No. WO86/05445 incorporated herein by reference.

The silane coupling agent is bonded with water from the air or the inorganic material to form a hydrolysis silanol. The silanol is bonded with inorganic filler. Accordingly, the silane coupling agent can bond with the matrix resin and glass fibers.

The glass fibers are treated with the silane coupling agent in a conventional manner. The glass fibers employed in the present invention can be coated with an amine-, acryl-, or epoxy-coupling agent which is selected from the group consisting of γ-amino propyltriethoxy silane, γ-amino propyltrimethoxy silane, N-(β-amino ethyl) γ-amino propyltriethoxy silane, γ-methacryloxy propyltriethoxy silane, γ-methacryloxy propyltrimethoxy silane, γ-glycidoxy propyltrimethoxy silane, and β(3,4-epoxyethyl) γ-amino propyltrimethoxy silane.

The glass fibers coated with γ-methacryloxy propyltriethoxy silane which is an acryl-coupling agent are preferred.

(C) Aminosilane Coupling Agent

In addition to any coupling agent which is used to treat the glass fibers, an aminosilane coupling agent is admixed with the matrix resin when the matrix resin is compounded. The aminosilane coupling agent is used in an amount of about 0.01 to 5.0 parts by weight, preferably about 0.05 to 1.5 parts by weight.

The examples of the aminosilane coupling agent are -amino propyltriethoxy silane, γ-amino propyltrimethoxy silane, γ-aminopropyl-tris(2-methoxy-ethoxy)silane, N-(β-amino ethyl) γ-amino propyltrimethoxy silane, (β-amino ethyl) γ-amino propyltriethoxy silane, and β(3,4-epoxyethyl) γ-amino propyltrimethoxy silane.

The new method of preparing the styrenic thermoplastic composite according to the present invention comprises admixing a styrene-containing copolymer as a matrix resin with an aminosilane coupling agent in a mixer, extruding the admixture of the styrene-containing copolymer and the aminosilane coupling agent in an extruder, and feeding glass fibers to the melt of the admixture in the middle of the extruder. In a typical process, the extruder temperature is about 220-280° C. and the glass fibers are fed to the middle of the extruder by means of a side-feeder. The method according to the present invention is used to lessen the breakage of the glass fibers.

The invention may be better understood by the reference to the following examples which are intended for the purpose of illustration and are not to be construed as in any way limiting the scope of the present invention. In the following examples, all parts and percentage are by weight unless otherwise indicated.

### EXAMPLES

The components to prepare styrenic thermoplastic resin compositions in Examples 1-6 and Comparative Examples 1-9 are as follows:

(A) Styrene-Containing Copolymer

(A1) Styrene/acrylonitrile (SAN) Copolymer: 28% by weight of acrylonitrile, 120,000 of weight average molecular weight

(A2) Styrene/acrylonitrile (SAN) Copolymer: 35% by weight of acrylonitrile, 140,000 of weight average molecular weight

(B) Glass Fibers

(B1) 13 μm of diameter, 3 mm of chopped length, coated with methacryloxysilane as coupling agent

(B2) 13 μμm of diameter, 3 mm of chopped length, coated with epoxysilane as coupling agent

(C) Aminosilane Coupling Agent and Comparative Coupling Agents

(C1) Epoxy Coupling Agent: glycidooxypropyltrimethoxy silane (KBM403 by Shinetsu Silicon Co.)

(C2) Aminosilane Coupling Agent: N-(β-amino ethyl) γ-amino propyltrimethoxy silane (KBM603 by Shinetsu Silicon Co.)

(C3) Acryl Coupling Agent: methacryloxypropyltrimethoxy silane (KBM503 by Shinetsu Silicon Co.)

(D) Modified Aromatic Vinyl Graft Copolymer (ABS)

Acrylonitrile-butadiene-styrene graft copolymer of 50% by weight of polybutadiene rubber contents, 14% by weight of acrylonitrile contents and 36% by weight of styrene was used.

### Examples 1-3

To reduce the breakage of glass fibers, the styrene-containing copolymer (A) was admixed with component (C) in a mixer. The mixture was extruded using a twin screw extruder of L/D=34 and Φ=40 mm at 220 to 280 extrusion temperature and 200 rpm. The glass fibers (B) were fed into the middle of the extruder. The resin composite was prepared in pellets. The pellets were dried at 80° C. for 3 hours and were molded into specimens through a 10 Oz mold at 220 to 280° C. Example 1 employed styrene-containing copolymer (Al) as a matrix resin, Example 2 employed styrene-containing copolymer (A2) as a matrix resin, and Example 3 employed a mixture of styrene-containing copolymer (A1) and styrene-containing copolymer (A2) as a matrix resin. Glass fibers (B1) and aminosilane coupling agent (C2) were used in Examples 1-3.

### Examples 4-6

Examples 4-6 were conducted in the same manner as Examples 1-3, respectively, except that glass fibers (B2) were used.

### Comparative Examples 1-3

Comparative Examples 1-3 were conducted in the same manner as Examples 1-3, respectively, except that aminosilane coupling agent (C2) was not used.

### Comparative Examples 4-6

Comparative Examples 4-6 were conducted in the same manner as Examples 1-3, respectively, except that epoxy coupling agent (C₁) was used.

### Comparative Examples 7-9

Comparative Examples 7-9 were conducted in the same manner as Examples 1-3, respectively, except that acryl coupling agent (C3) was used.

The components of the Examples and Comparative Examples are shown in Table 1.

TABLE 1

| | | Examples | | | | | | Comparative Examples | | | | | | | | |
|---|---|---|---|---|---|---|---|---|---|---|---|---|---|---|---|---|
| | | 1 | 2 | 3 | 4 | 5 | 6 | 1 | 2 | 3 | 4 | 5 | 6 | 7 | 8 | 9 |
| SAN | (A1) | 80 | — | 40 | 80 | — | 40 | 80 | — | 40 | 80 | — | 40 | 80 | — | 40 |
| | (A2) | — | 80 | 40 | — | 80 | 40 | — | 80 | 40 | — | 80 | 40 | — | 80 | 40 |
| Glass | (B1) | 20 | 20 | 20 | — | — | — | 20 | 20 | 20 | 20 | 20 | 20 | 20 | 20 | 20 |
| Fibers | (B2) | — | — | — | 20 | 20 | 20 | — | — | — | — | — | — | — | — | — |
| Epoxy | (C1) | — | — | — | — | — | — | — | — | — | 0.2 | 0.2 | 0.2 | — | — | — |
| Amino | (C2) | 0.2 | 0.2 | 0.2 | 0.2 | 0.2 | 0.2 | — | — | — | — | — | — | — | — | — |
| Acryl | (C3) | — | — | — | — | — | — | — | — | — | — | — | — | 0.2 | 0.2 | 0.2 |

For the specimens of Examples 1-6 and Comparative Examples 1-9, Izod notch impact strength was measured in accordance with ASTM D256, flexural modulus was measured in accordance with ASTM D790, and VST was measured in accordance with ASTM D1525. Further, for the specimens, Dupont Drop Test was conducted using a weight of 1 kg. The heights were measured when the specimens were destroyed up to 50%. For each example, 20 specimens were tested. The test results are shown in Table 2.

TABLE 2

| | | | |
|---|---|---|---|
| | Flexural | | |
| Izod Impact | Modulus | | Dupont |
| Strength | (2.8 mm/min, | VST | Drop Test |
| (1/8, kg.cm/cm) | kg/cm2) | (1/4″, ° C.) | (cm) |

Examples

| | | | | |
|---|---|---|---|---|
| 1 | 6.0 | 66,000 | 105 | 65 |
| 2 | 6.2 | 69,000 | 106 | 67 |
| 3 | 6.3 | 68,600 | 105 | 66 |
| 4 | 5.8 | 66,200 | 105 | 61 |
| 5 | 6.1 | 68,900 | 106 | 62 |
| 6 | 5.9 | 69,000 | 105 | 62 |

Comparative Examples

| | | | | |
|---|---|---|---|---|
| 1 | 5.8 | 66,300 | 106 | 55 |
| 2 | 5.1 | 68,000 | 106.5 | 55 |
| 3 | 5.2 | 68,600 | 106.2 | 56 |
| 4 | 5.7 | 66,000 | 105 | 57 |
| 5 | 5.5 | 69,000 | 106 | 57 |
| 6 | 5.7 | 68,600 | 105 | 58 |
| 7 | 5.5 | 66,100 | 106 | 54 |
| 8 | 5.2 | 69,000 | 106.5 | 57 |
| 9 | 5.0 | 68,400 | 106.2 | 56 |

As shown in Table 2, when the aminosilane coupling agent (C2) is admixed in the matrix resin, the Izod impact strength improves and the Dupont drop test shows excellent results. Further, the mechanical strength such as Flexural Modulus does not decrease. When SAN (A2) with a higher content of acrylonitrile is used as a matrix resin, better physical properties are shown.

### Examples 7-10

Examples 7-10 were conducted in the same manner as Example 1 varying the amount of Aminosilane Coupling Agent (C2) respectively. Examples 7-9 employed styrene-containing copolymer (A1) as a matrix resin and Example 10 employed a mixture of styrene-containing copolymer (A1) and ABS (D) as a matrix resin. Comparative Examples 10-13 Comparative Examples 10-13 were conducted in the same manner as Examples 7-10 except that the epoxy coupling agent (C1) or acryl coupling agent (C3) was used.

The test results of the compositions and the physical properties of Examples 7-10 and Comparative Examples 10-13 are shown in Table 3.

TABLE 3

| | | Examples | | | | Comparative Examples | | | |
|---|---|---|---|---|---|---|---|---|---|
| | | 7 | 8 | 9 | 10 | 10 | 12 | 13 | 14 |
| SAN | (A1) | 80 | 80 | 80 | 55 | 80 | 80 | 80 | 55 |
| Glass Fibers | (B1) | 20 | 20 | 20 | 20 | 20 | 20 | 20 | 20 |
| Coupling Agent | (C1) | — | — | — | — | 0.1 | — | — | — |
| Coupling Agent | (C2) | 0.1 | 0.5 | 1.0 | 1.2 | — | — | — | — |
| Coupling Agent | (C3) | — | — | — | — | — | 0.5 | 1.0 | 1.2 |
| ABS | (D) | — | — | — | 25 | — | — | — | 25 |

| | | | | | | | | |
|---|---|---|---|---|---|---|---|---|
| Izod Impact Strength | 5.8 | 6.3 | 6.2 | 8.1 | 5.5 | 5.6 | 5.6 | 7.5 |
| Flexural Modulus | 66300 | 65200 | 64000 | 55400 | 67000 | 65000 | 63400 | 56100 |
| VST | 106 | 105 | 103 | 100 | 105 | 103 | 100 | 98 |
| Dupont Drop Test | 61 | 69 | 68 | 120 | 57 | 60 | 61 | 90 |

As shown in Table 3, when ABS (D) is admixed with the matrix resin, both the Izod impact strength and the Dupont drop test show excellent results.

Modifications and changes and the use of equivalent components and amounts thereof that provide comparable results are deemed to be with the scope of the present invention.

What is claimed is:

1. A styrenic thermoplastic resin composite comprising:
(A) about 50 to 95 parts by weight of a styrene-containing copolymer prepared by polymerization of:
(a1) about 50 to 95% by weight of styrene, α-methylstyrene, halogen- or alkyl-substituted styrene, or a mixture thereof and
(a2) about 5 to 50% by weight of acrylonitrile, methacrylonitrile, C₁₋₈ methacrylic acid alkyl ester, C₁₋₈ acrylic acid alkyl ester, maleic acid anhydride, C₁₋₄ alkyl or phenyl 10 N-substituted maleimide or a mixture thereof;
(B) about 5 to 50 parts by weight of glass fibers; and
(C) about 0.05 to 1.5 parts by weight of an aminosilane coupling agent.

2. The composite according to claim 1, wherein said aminosilane coupling agent is selected from the group consisting of γ-amino propyltriethoxy silane, γ-amino propyltrimethoxy silane, γ-aminopropyl-tris(2-methoxy-ethoxy)silane, N-(β-amino ethyl) γ-amino propyltrimethoxy silane, N-(β-amino ethyl) γ-amino propyltriethoxy silane, and β(3,4-epoxyethyl) γ-amino propyltrimethoxy silane.

3. The composite according to claim 1, wherein the glass fibers are used in the amount of 10 to 40 parts by weight.

4. The composite according to claim 1, wherein said glass fibers are treated with a coupling agent represented by the following formula:
YRSiX₃
where Y is an organic functional group that can react with a matrix resin, which is selected from the group consisting of vinyl, epoxy, mercaptan, amine and acryl, R is a C₁₋₅ alkyl group and X is an ethoxy group or a halogen atom.

5. The composite according to claim 1, wherein said glass fibers are treated with γ-methacryloxy propyltriethoxy silane.

6. The composite according to claim 1, wherein said component (a1) is about 50 to 70% by weight and component (a2) is about 30 to 50% by weight of the styrene containing copolymer.

7. The composite according to claim 1, further comprising up to about 35 parts by weight of a modified aromatic vinyl graft copolymer.

8. The composite according to claim 7, wherein said modified aromatic vinyl graft copolymer is prepared by grafting about 22 to 99% by weight of an aromatic vinyl monomer mixture onto about 1 to 80% by weight of a rubber polymer.

9. The composite according to claim 8, wherein the aromatic vinyl monomer mixture comprises (D1) styrene, parα-t-butylstyrene, alphα-methylstyrene, betα-methylstyrene, vinylxylene, monochlorostyrene, dichlorostyrene, dibromostyrene, chlrorostyrene, ethylstyrene, vinylnaphthalene, divinylbenzene, or a mixture thereof, and (D2) acrylonitrile, methacrylonitrile, acrylic acid ester, maleic acid anhydride or a mixture thereof.

10. An molded article prepared using the styrenic thermoplastic resin composite according to claim 1.

11. A styrenic thermoplastic resin composite comprising:
(A) about 50 to 95 parts by weight of a styrene-containing copolymer prepared by polymerization of:
(a1) about 50 to 95% by weight of styrene, α-methylstyrene, halogen- or alkyl-substituted styrene, or a mixture thereof and
(a2) about 5 to 50% by weight of acrylonitrile, methacrylonitrile, C₁₋₈ methacrylic acid alkyl ester, C₁₋₈ acrylic acid alkyl ester, maleic acid anhydride, C₁₋₄ alkyl or phenyl N-substituted maleimide or a mixture thereof;
(B) about 5 to 50 parts by weight of glass fibers; and
(C) about 0.05 to 1.5 parts by weight of an aminosilane coupling agent
wherein the styrenic thermoplastic resin composite is prepared by:
admixing a styrene-containing copolymer (A) as a matrix resin with an amninosilane coupling agent in a mixer;
extruding the admixture of the styrene-containing copolymer and the aminosilane coupling agent (C) in an extruder; and
feeding glass fibers (B) in the middle of the extruder into the melt of the admixture of (A) and (C).

12. The composite according to claim 11, wherein said aminosilane coupling agent is selected from the group consisting of γ-amino propyltriethoxy silane, γ-amino propyltrimethoxy silane, γ-aminopropyl-tris(2-methoxy-ethoxy)silane, N-(β-amino ethyl) γ-amino propyltrimethoxy silane, N-(β-amino ethyl) γ-amino propyltriethoxy silane, and β(3,4-epoxyethyl) γ-amino propyltrimethoxy silane.

13. A styrenic thermoplastic resin composite comprising:
(A) about 50 to 95 parts by weight of a styrene-containing copolymer prepared by polymerization of:
(a1) about 50 to 95% by weight of styrene, α-methylstyrene, halogen- or alkyl-substituted styrene, or a mixture thereof and
(a2) about 5 to 50% by weight of acrylonitrile, methacrylonitrile, C₁₋₈, methacrylic acid alkyl ester, C₁₋₈ acrylic acid alkyl ester, maleic acid anhydride, C₁₋₄ alkyl or phenyl N-substituted maleimide or a mixture thereof;
(B) about 5 to 50 parts by weight of glass fibers; and
(C) about 0.01 to 5.0 parts by weight of an aminosilane coupling agent.

14. The composite according to claim 13, wherein said aminosilane coupling agent is selected from the group consisting of γ-amino propyltriethoxy silane, γ-amino propyltrimethoxy silane, γ-aminopropyl-tris(2-methoxy-ethoxy)silane, N-(β-amino ethyl) γ-amino propyltrimethoxy silane, N-(β-amino ethyl) γ-amino propyltriethoxy silane, and β(3,4-epoxyethyl) γ-amino propyltrimethoxy silane.

15. The composite according to claim 13, wherein the glass fibers are used in an amount of about 10 to 40 parts by weight.

16. The composite according to claim 1, wherein said glass fibers are treated with a coupling agent.

17. A method of preparing a styrenic thermoplastic resin composite comprising:
admixing a styrene-containing copolymer as a matrix resin with an aminosilane coupling agent in a mixer;
extruding the admixture of the styrene-containing copolymer and the aminosilane coupling agent in an extruder; and
feeding glass fibers in the middle of the extruder into the melt of the admixture.

18. The method according to claim 17 wherein about 50 to 95 parts by weight of a styrene-containing copolymer is used wherein the styrene-containing copolymer is prepared by polymerization of (al) about 50 to 95% by weight of styrene, α-methylstyrene, halogen- or alkyl-substituted styrene, or a mixture thereof and (a2) about 5 to 50% by weight of acrylonitrile, methacrylonitrile, C₁₋₈ methacrylic acid alkyl ester, C₁₋₈ acrylic acid alkyl ester, maleic acid anhydride, C₁₋₄ alkyl or phenyl N-substituted maleimide or a mixture thereof; and about 5 to 50 parts by weight of glass fibers and about 0.01 to 5.0 parts by weight of an aminosilane coupling agent are used.
